(19) United States
(12) Patent Application Publication
(10) Pub. No.: US 2004/0213408 A1
(43) Pub. Date: Oct. 28, 2004

(54) Method for managing copy protection information of recording medium

(76) Inventors: Byung Jin Kim, Kyunggi-do (KR); Hyung Sun Kim, Seoul (KR); Alexandre Stechkine, Seoul (KR)

Correspondence Address: BIRCH STEWART KOLASCH & BIRCH, PO BOX 747, FALLS CHURCH, VA, 22040-0747, US

(21) Appl. No.: 10/831,197

(22) Filed: Apr. 26, 2004

(30) Foreign Application Priority Data
Apr. 24, 2003 (KR) 10-2003-0026151

(51) Int. Cl. H04N 7/167

(52) U.S. Cl. 380/200

(57) ABSTRACT

A method for managing copy protection information of a recording medium is disclosed. A data stream encrypted using copy protection information is recorded in a data area of an optical disc such as a write once optical disc or a rewritable optical disc, while the copy protection information and Digital Rights Management (DRM) information set by a content provider are recorded together in a key locker of the optical disc. When a data stream of an optical disc is reproduced, the operation of reproducing or copying the encrypted data stream is controlled according to information of allowed playback time, the number of copy times and copy permission/prohibition information, which is included in the Digital Rights Management information. This effectively prevents contents such as data files transmitted over the Internet from being illegally duplicated.

### BACKGROUND OF THE INVENTION

1. Field of the Invention

The present invention relates to a method for managing copy protection information of a recording medium, and more particularly to a method for improving the security of copy protection information for decrypting A/V data encrypted and recorded in a data area of an optical disc such as a write once optical disc or a rewritable optical disc.

2. Description of the Related Art

Generally, an optical disc, for example a CD or a DVD, capable of recording digital video or audio data has been widely used and commercialized, and as the standardization of a high-density optical disc such as a BD has progressed rapidly, related products are expected to be commercialized in the near future.

To prevent illegal and unauthorized duplication of contents of digital video or audio data recorded in such an optical disc, a copy protection information management method has been proposed in which A/V data encrypted using copy protection information is recorded in a data area of an optical disc and the copy protection information is recorded and managed in a specific area, such as a lead-in area, of the optical disc. This method is described in detail as follows.

FIG. 1 is a block diagram showing the configuration of an optical disc drive 200 and an application 300 to which a general method for managing copy protection information of DVDs is applied. As shown in FIG. 1, the optical disc drive 200 may include an authentication block 20, a key sharing block 21, and encryption blocks 22 and 23.

The application 300 such as a personal computer (PC) may include an authentication block 30, a key sharing block 31, decryption blocks 32 and 33, a descrambler block 34, a decompression block 38, a description disc key 36, and a description title key 37.

An authentication control key, a secured disc key, an encrypted title key, and scrambled A/V data may be stored in a DVD 100 to be inserted into the optical disc drive 200.

The authentication block 20 of the optical disc drive 200 uses an authentication control key read from the DVD 100 to perform a series of authentication processes for transmission and reception of data to and from the authentication block 30 of the application 300. Using a predetermined encryption key provided from the key sharing block 21, the encryption blocks 22 and 23 re-encrypt a secured disc key and an encrypted title key read from the DVD 100 into data suitable for transmission and reception, and then transmit the re-encrypted data.

Using a predetermined description key provided from the key sharing block 31, the decryption blocks 32 and 33 of the application 300 perform a series of operations to decrypt a secured disc key and an encrypted title key received from the optical disc drive 200.

The disc key is decrypted using a master key 35 managed in the application 300, and the title key is decrypted using the decrypted disc key. The descrambler block 34 uses the title key to descramble scrambled A/V data read from the DVD 100. The decompression block 38 decompresses the descrambled A/V data to output original A/V data. Such processes make it possible to prevent unauthorized and illegal duplication of contents of audio or video data scrambled and recorded in the DVD 100.

However, the copy protection information such as the secured disc key and the encrypted title key recorded in the DVD may be illegally hacked and distributed by a third party such as a hacker, allowing illegal duplication of the A/V data encrypted and recorded in the data area of the DVD. It is thus urgently needed to provide an effective solution that can sufficiently reinforce the security of the copy protection information, and particularly to provide an effective solution that can prevent illegal duplication of contents transmitted over the Internet.

### SUMMARY OF THE INVENTION

Therefore, the present invention has been made in view of the above problems, and it is an object of the present invention to provide a method and apparatus for managing copy protection information of a recording medium, which significantly reinforces the security of copy protection information.

It is another object of the present invention to provide a method and apparatus for managing copy protection information of a recording medium, which can effectively prevent illegal duplication of contents transmitted over the Internet.

It is yet another object of the present invention to provide a method and apparatus for managing copy protection information of a recording medium, which can control the operation of playing and copying an optical disc in which contents containing Digital Rights Management information are recorded.

In accordance with the present invention, the above and other objects can be accomplished by the provision of a method for managing copy protection information of a recording medium, the method comprising: encrypting a data stream based on copy protection information recorded in a first specific area of a recording medium, and recording the encrypted data stream in a data area of the recording medium; and recording Digital Rights Management information for the data stream in the first specific area.

In accordance with another aspect of the present invention, there is provided a method for managing copy protection information of a recording medium, the method comprising the steps of: a) confirming Digital Rights Management information recorded in a first specific area of a recording medium; and b) decrypting the copy protection information recorded in the first specific area according to the confirmed Digital Rights Management information; and c) decrypting a data stream, encrypted and recorded in a data area of the recording medium, using the decrypted copy protection information.

In accordance with a further aspect of the present invention, there is provided a recording medium, comprising: a data area in which a data stream encrypted using copy protection information is recorded; and a first specific area in which the copy protection information and Digital Rights Management information of the data stream are recorded.

In accordance with yet another aspect of the present invention, there is provided an apparatus for recording and reproducing data in a recording medium, the apparatus comprising: a pickup unit for recording data in the recording medium or reading data from the recording medium; a copy protection information calculation unit for decrypting copy protection information encrypted and recorded in a first specific area of the recording medium; a data processing unit for decrypting data read from the recording medium or encrypting data to be recorded in the recording medium, using the copy protection information; and a Digital Rights Management information module for analyzing and updating Digital Rights Management information of the data, and controlling the decryption of the copy protection information, based on the Digital Rights Management information, wherein a data stream encrypted using the copy protection information is recorded in a data area of the recording medium, and Digital Rights Management information of the data stream is recorded in the first specific area.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of an optical disc drive and an application to which a general method for managing copy protection information of a DVD is applied;

FIGS. 2 and 3 are block diagrams showing the configuration of an optical disc drive to which a method for managing copy protection information of a recording medium according to one embodiment of the present invention is applied;

FIGS. 4 and 5 are block diagrams showing the configuration of an optical disc drive and an application to which a method for managing copy protection information of a recording medium according to another embodiment of the present invention is applied; and

FIG. 6 is a diagram illustrating how Digital Rights Management information is managed in the method for managing the copy protection information of the recording medium according to one embodiment of the present invention.

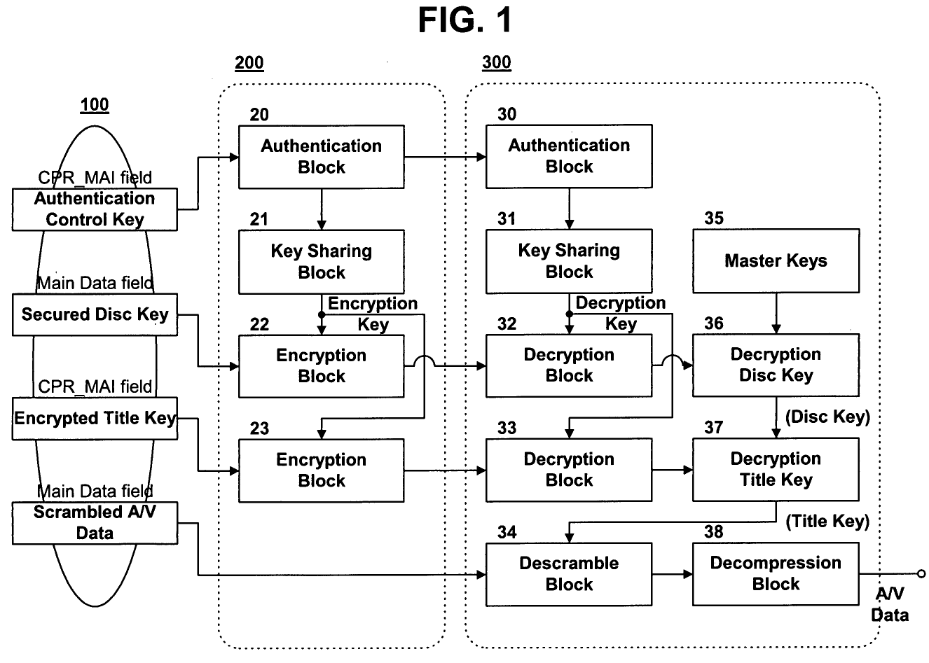

### DETAILED DESCRIPTION OF PREFERRED EMBODIMENTS

Preferred embodiments of a method for managing copy protection information of a recording medium according to the present invention will now be described in detail with reference to the accompanying drawings.

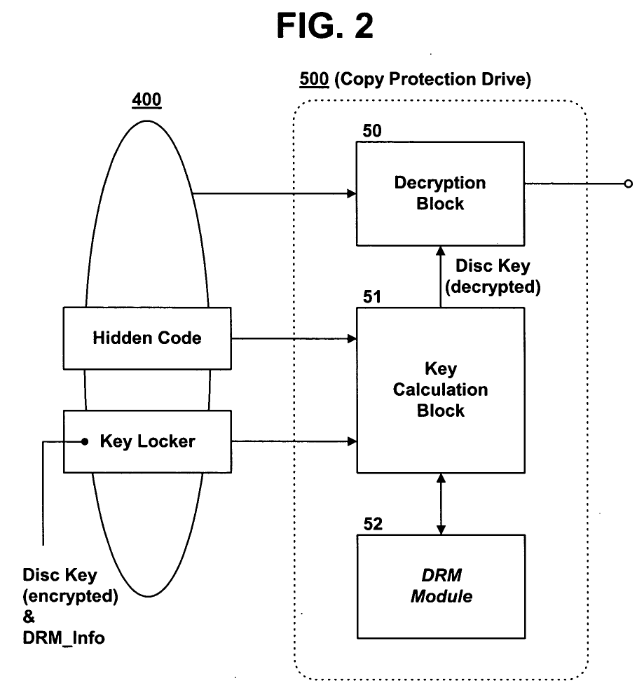

FIG. 2 is a block diagram showing the configuration of an optical disc drive 500 to which the method for managing the copy protection information of the recording medium according to the present invention is applied. As shown in this figure, the optical disc drive 500 may include a decryption block 50, a key calculation block 51, and a DRM (Digital Rights Management) module 52.

Copy protection information (for example an encrypted disc key) and DRM information set by a content provider are recorded in a key locker provided in an optical disc 400 to be inserted into the optical disc drive 500. In addition, a hidden code for reading and decrypting the disc key and the DRM information is recorded in a specific area of the optical disc 400.

The hidden code is recorded, in the form of wobble pre-pits (as a wobble pre-pit type) or in the form of a physical wobble having a low frequency component, in a specific area of the optical disc 400, for example in a pre-recorded (embossed) area of a lead-in area of the optical disc 400, so that it cannot be illegally duplicated using a bit to bit copy.

The DRM information is management information that is used to control the operation of playing or copying a data stream encrypted and recorded in a data area of the optical disc 400. For example, the DRM information is management information such as an allowed playback time (for example, period of validity or time limit), the number of copy times (i.e., duplication limit) and copy permission/prohibition that a content provider providing data files of various contents optionally sets to prevent illegal duplication of the data files.

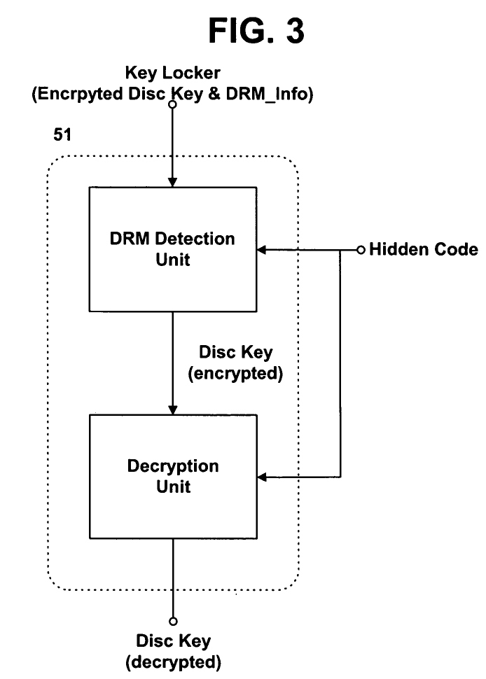

As shown in FIG. 3, the key calculation block 51 of the optical disc drive 500 may include a DRM detection unit (not referenced) and a decryption unit (not referenced). The DRM detection unit detects DRM information recorded in the key locker using the hidden code, and the decryption unit decrypts a disc key recorded in the key locker using the hidden code. The decryption unit selectively performs the operation of decrypting the disc key, based on the DRM information detected by the DRM detection unit. For example, if the allowed playback time (for example, period of validity or time limit) set in the DRM information has expired, the decryption unit does not perform the operation of decrypting the disc key.

With reference to the DRM information detected by the DRM detection unit, the DRM module 52 controls the operation of the key calculation block 51 or controls the operation of reproducing and copying data in an application (for example, a personal computer) connected with the optical disc drive 500.

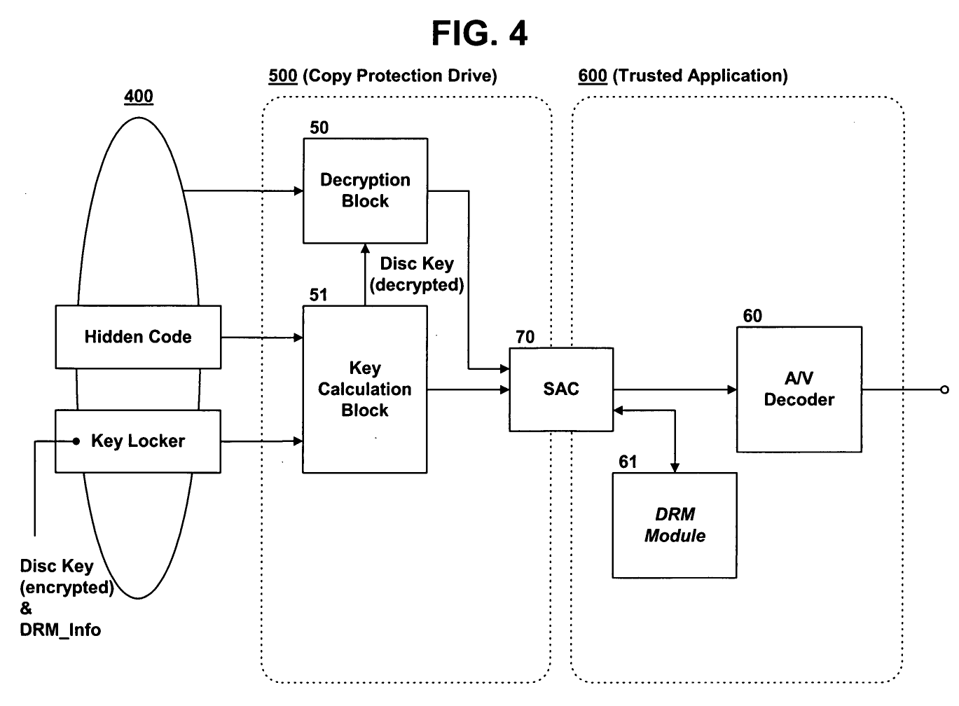

As shown in FIG. 4, the optical disc drive 500 transmits and receives data to and from an application 600 such as a personal computer through a secure authenticated channel (SAC) 70, and the application 600 includes an A/V decoder 60 for decoding A/V data received through the secure authenticated channel 70.

The DRM module 52 may be provided not in the disc drive 500 but in the application 600. In this case, a DRM module 61 provided in the application 600 receives DRM information read from the DRM detection unit of the key calculation block 51 through the secure authenticated channel 70, and stores the received DRM information. After receiving and storing the DRM information, the DRM module 61 controls the decoding operation of the A/V decoder 60 or controls the operation of the key calculation block 51 through the secure authenticated channel 70, so as to prevent the data stream encrypted and recorded in the data area of the optical disc from being illegally duplicated or being reproduced an unlimited number of times.

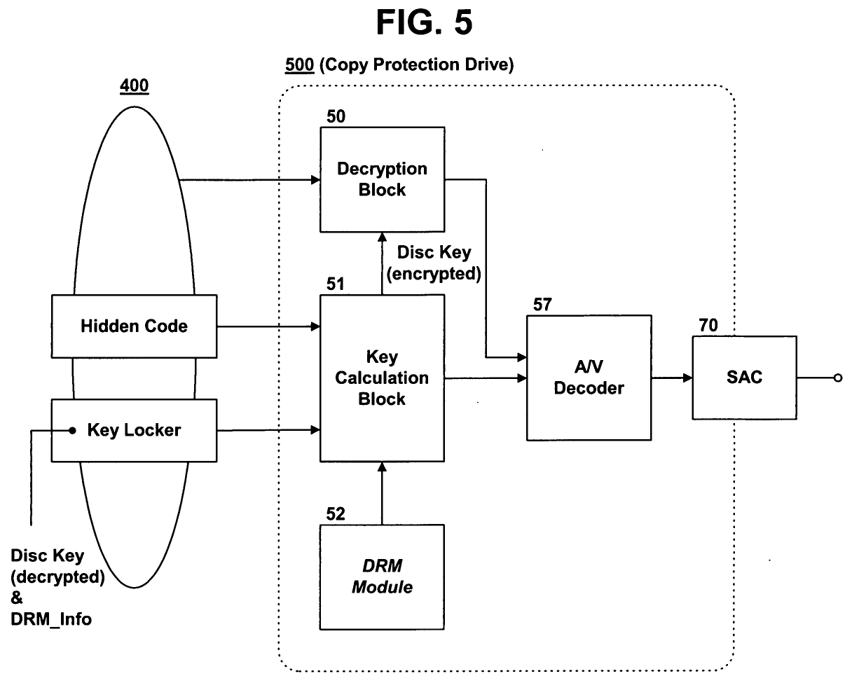

As shown in FIG. 5, an A/V decoder 57 may also be provided not in the application 600 but in the optical disc drive 500. In this case, since the optical disc drive 500 outputs completely decoded audio and video data to the application 600 through the secure authenticated channel 70, the optical disc drive 500 can reduce the risk of hacking of the copy protection information, compared to when bit streams of the audio and video data are transmitted directly to the application 600 as shown in FIG. 4.

The optical disc, in which the disc key and the DRM information are recorded together in the key locker thereof and the hidden code is recorded in the specific area thereof as described above, may be a write once optical disc or a rewritable optical disc.

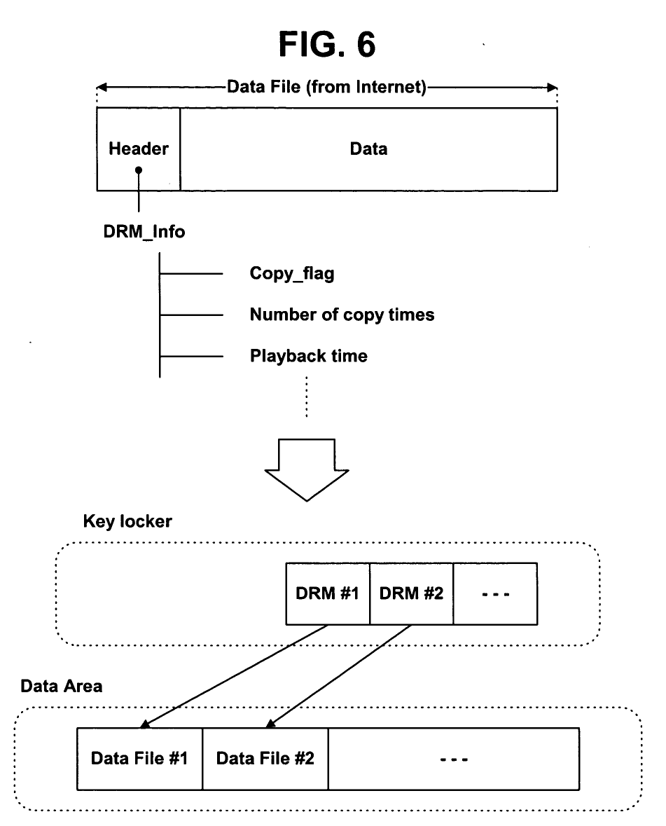

As shown in FIG. 6, the header of a data file of various contents provided over the Internet may include a copy flag (Copy_Flag) for setting whether copying is allowed or not, information for setting the number of copy times, and playback time information for setting an allowed playback time.

The optical disc drive 500 records data files (Data File #1, #2, . . . ), received through the Internet, in a data area of an optical disc, and also records a plurality of DRM information (DRM #1, #2, . . . ), included in respective headers of the received data files (Data File #1, #2, . . . ), in a key locker of the optical disc while dividing the plurality of DRM information according to the data files.

The copy protection information and the hidden code are previously recorded in the optical disc when the optical disc is manufactured, and the data files are recorded in the data area of the optical disc after being encrypted using the copy protection information. For reference, the disc key included in the key locker or the like can also be recorded in the lead-in area of the optical disc in the form of wobble pre-pits (as a wobble pre-pit type) or in the form of a physical wobble having a low frequency component, as with the hidden key. Here, the DRM information is recorded in the form of pits along a wobble track in a recordable or rewritable area in the key locker. When playing and copying an optical disc, the optical disc drive 500 updates DRM information recorded in a key locker of the optical disc.

For the optical disc in which the data files and the DRM information are updated and recorded in the manner described above, the optical disc drive 500 performs restrictive playing and copying operations according to the DRM information. This makes it possible to prevent the data files recorded in the optical disc from being illegally duplicated or being reproduced an unlimited number of times.

As apparent from the above description, the present invention can significantly improve the security of copy protection information.

The present invention can also prevent contents transmitted over the Internet from being illegally duplicated.

The present invention also makes it possible to control the operation of reproducing and copying contents containing Digital Rights Management (DRM) information.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for managing copy protection information of a recording medium, the method comprising:
encrypting a data stream based on copy protection information recorded in a first specific area of a recording medium, and recording the encrypted data stream in a data area of the recording medium; and
recording Digital Rights Management information for the data stream in the first specific area.

2. The method according to claim 1, wherein the recording medium is a write once optical disc or a rewritable optical disc.

3. The method according to claim 1, wherein the Digital Rights Management information is used to control copying or playback of the data stream.

4. The method according to claim 3, wherein the Digital Rights Management information includes an allowed playback time of the data stream, the number of copy times thereof, and information as to whether copying thereof is allowed or not.

5. The method according to claim 1, wherein the data stream is a data file received over a network.

6. The method according to claim 5, wherein the Digital Rights Management information is read from header information of the data file.

7. The method according to claim 5, wherein the Digital Rights Management information is recorded while being divided according to data files.

8. The method according to claim 1, wherein a hidden code for decrypting the copy protection information and the Digital Rights Management information is recorded in a second specific area of the recording medium.

9. The method according to claim 8, wherein the hidden code is recorded in the form of a wobble having a low frequency component that is not duplicated using a bit to bit copy.

10. A method for managing copy protection information of a recording medium, the method comprising the steps of:
a) confirming Digital Rights Management information recorded in a first specific area of a recording medium; and
b) decrypting the copy protection information recorded in the first specific area according to the confirmed Digital Rights Management information; and
c) decrypting a data stream, encrypted and recorded in a data area of the recording medium, using the decrypted copy protection information.

11. The method according to claim 10, wherein the Digital Rights Management information is used to control copying or playback of the data stream.

12. The method according to claim 11, wherein the Digital Rights Management information is managed while being divided according to data files corresponding to the data stream.

13. The method according to claim 12, wherein the copy protection information is decrypted only if information of a data file to be reproduced or copied, said information being included in the confirmed Digital Rights Management information, satisfies a playback or copying condition of the data file.

14. The method according to claim 12, further comprising the step of, if playback or copying of a data file is performed, updating information regarding the performed playback or copying, included in Digital Rights Management information of the data file, and recording the updated information in the first specific area, overwriting with the updated information.

15. The method according to claim 10, wherein the copy protection information and the Digital Rights Management information are decrypted using a hidden code recorded in a second specific area of the recording medium, said hidden code being recorded in the form of a wobble having a low frequency component that is not duplicated using a bit to bit copy.

16. A recording medium, comprising:
a data area in which a data stream encrypted using copy protection information is recorded; and
a first specific area in which the copy protection information and Digital Rights Management information of the data stream are recorded.

17. The medium according to claim 16, wherein the recording medium is a write once optical disc or a rewritable optical disc.

18. The medium according to claim 16, wherein the Digital Rights Management information is used to control copying or playback of the data stream.

19. The medium according to claim 16, wherein the Digital Rights Management information is recorded while being divided according to data files corresponding to the data stream.

20. The medium according to claim 16, further comprising a second specific area in which a hidden code for decrypting the copy protection information and the Digital Rights Management information is recorded.

21. The medium according to claim 20, wherein the copy protection information and the hidden code are recorded in the recording medium when the recording medium is manufactured.

22. The medium according to claim 20, wherein the hidden code is recorded in the form of a wobble having a low frequency component that is not duplicated using a bit to bit copy.

23. An apparatus for recording and reproducing data in a recording medium, the apparatus comprising:
a pickup unit for recording data in the recording medium or reading data from the recording medium;
a copy protection information calculation unit for decrypting copy protection information encrypted and recorded in a first specific area of the recording medium;
a data processing unit for decrypting data read from the recording medium or encrypting data to be recorded in the recording medium, using the copy protection information; and
a Digital Rights Management information module for analyzing and updating Digital Rights Management information of the data, and controlling the decryption of the copy protection information, based on the Digital Rights Management information,
wherein a data stream encrypted using the copy protection information is recorded in a data area of the recording medium, and Digital Rights Management information of the data stream is recorded in the first specific area.

24. The apparatus according to claim 23, wherein the Digital Rights Management information is used to control copying or playback of the data stream.

25. The apparatus according to claim 24, wherein the Digital Rights Management information is recorded while being divided according to data files corresponding to the data stream.

26. The apparatus according to claim 23, wherein when a data stream containing Digital Rights Management information is encrypted and recorded in the data area, the Digital Rights Management information module separates the Digital Rights Management information from the data stream and updates the Digital Rights Management information, and the pickup unit additionally records the updated Digital Rights Management information in the first specific area of the recording medium.

27. The apparatus according to claim 26, wherein the data stream containing the Digital Rights Management information is a data file received over a network, and the Digital Rights Management information is read from header information of the data file.

28. The apparatus according to claim 23, wherein when a data file corresponding to the data stream recorded in the recording medium is reproduced or copied, the pickup unit reads Digital Rights Management information of the data file from the first specific area; the Digital Rights Management information module analyzes the read Digital Rights Management information to confirm whether a playback or copying condition of the data file is satisfied; the copy protection information calculation unit decrypts copy protection information only if the playback or copying condition of the data file is satisfied; and the data processing unit decrypts the data stream read from the data area of the recording medium using the decrypted copy protection information.

29. The apparatus according to claim 28, wherein when playback or copying of a data file is performed, the Digital Rights Management information module updates information regarding the performed playback or copying, included in Digital Rights Management information of the data file, and the pickup unit records the updated information in the first specific area, overwriting with the updated information.

30. The apparatus according to claim 23, wherein the copy protection information calculation unit decrypts the copy protection information and the Digital Rights Management information using a hidden code recorded in a second specific area of the recording medium, said hidden code being recorded in the form of a wobble having a low frequency component that is not duplicated using a bit to bit copy.
